(19) United States
(12) Patent Application Publication
(10) Pub. No.: US 2011/0252620 A1
(43) Pub. Date: Oct. 20, 2011

(54) Illumination arrangement to be created by foam forms and method of installing the same

(75) Inventors: Richard d. Ashoff, Newport Beach, CA (US); James R. Zarian, Corona del Mar, CA (US)

(73) Assignee: Richard d. Ashoff

(21) Appl. No.: 13/064,038

(22) Filed: Mar. 3, 2011

Related U.S. Application Data
(60) Provisional application No. 61/282,588, filed on Mar. 4, 2010.

(51) Int. Cl. B23P 11/00

(52) U.S. Cl. 29/428

(57) ABSTRACT

The present invention pertains to the field of illumination and more particularly to illumination elements and illumination arrangements, whereby the illumination consist of at least one illumination element embedded in structures, the structures formed using molds and more particularly foam forms or foam molds. The illumination element consists of an encased, LED edge-lit panel or similar illumination sources. The methods and processes for embedding the at least one illumination element or illumination arrangements are disclosed. Two exemplary variations of methods and processes are disclosed in the present invention.

### CLAIM OF PRIORITY

This application is a non-provisional patent application claiming priority to U.S. Provisional Patent Application No. 61/282,588, filed on Mar. 4, 2010, which is incorporated herein by reference.

### TECHNICAL FIELD

The present invention pertains to the field of illumination and more particularly to illumination elements and illumination arrangements, whereby the illumination consist of at least one illumination element embedded in structures, the structures formed using molds and more particularly foam forms or foam molds. The illumination element consists of an encased, LED edge-lit panel or similar illumination sources. The methods and processes for embedding the at least one illumination element or illumination arrangements are disclosed. Two exemplary variations of methods and processes are disclosed in the present invention.

### BACKGROUND OF THE INVENTION

Light emitting diodes have recently been used in many architectural applications as an aesthetic, structural or functional elements. For example, light emitting diodes (LEDs) have been used in cove lighting and step lighting among other architectural applications as an aesthetic, structural or functional elements. In some applications organic LEDs (OLEDs) have served the same functions as LEDs. LEDs and OLEDs offer many advantages such as energy saving, longer life, smaller physical form, not containing dangerous gases among many other advantages in comparison to other lamp technologies such as incandescent, fluorescent, high intensity discharge and the like. LEDs have further been enhanced by the use of nanocrystals otherwise known as quantum dots (QD) or LED/QD. Hereinafter, any reference to LEDs also refers to OLEDs and LED/QD combinations.

LEDs have further been combined with light guides such as flat light guides (e.g., panels) to disperse the light evenly and uniformly as is well known in the art for backlighting of displays (i.e., backlighting of liquid crystal displays for smart cell phone displays, GPS displays, tablet computer displays and the like). As the cost of LEDs and other components for creating LED panel systems (“LED/PS”) has substantially decreased in recent times, the LED panels have been used in other applications such as architectural lighting as disclosed in U.S. patent application Ser. No. 12/662,051. Encasing or enclosing LED/PSs to protect the LED panels and related components against environmental elements such as water, dirt intrusion and handling among other calamities has further enhanced the usefulness of LED/PS (see U.S. application Ser. No. 12/662,051). A single enclosed or encased LED/PS is referred to as an “illumination element” in the present invention.

Creating architectural, and/or aesthetic effects such as concrete coping for pool decks, caps for cinder blocks, countertops, fireplace surrounds and the like using “foam forms” are well known. Illumination elements can further augment and enhance the visual effects of these architectural, aesthetic or structural forms. Hereinafter, arrangements and illumination arrangements refer to more than one LED/PS illuminating element used in one structure.

This invention pertains to illumination and, more particularly, it pertains to LED/PS encased within polymeric material (e.g., illumination element) for protection against environmental elements and handling mishaps during installation, where aesthetic, architectural or structural forming foam forms are used. In exemplary variations, the methods and processes of installing illumination elements for back lighting in the coping face of swimming pools is disclosed as an exemplary installation. In the last step of the processes, the illumination elements and/or arrangements may accept and backlight solid objects or artifact(s) such as glass blocks or tiles as will be disclosed.

There are many variation of methods or processes for forming the arrangements of the present invention. In one exemplary variation, the steps include: the step of creating a space or cavity for installation of illuminating element(s) as well as defining the contour of coping by the use of foam forms, next installation of illuminating element(s), and finally, the step of adding solid objects or artifact(s), if desired. And in another exemplary variation, the steps include: the step of installing illumination element(s) to the shelf face of the foam form, and installing the illumination element and concurrently defining the contour of coping and finally, the step of adding solid objects or artifacts, if desired. In both variations the foam form creates the desired concrete or aggregate contour after pouring and curing has been completed. Following curing of the aggregate, the form is removed to expose the face of the illumination assembly to backlight an solid objects or artifact, if desired, in the face of the coping according to the present invention.

For simplicity and clarity of illustration, the drawing figures illustrate the general manner of construction, and descriptions and details of well-known features and techniques may be omitted to avoid unnecessarily obscuring of the drawings. Additionally, elements in the drawing figures are not necessarily drawn to scale. For example, the dimensions of some of the elements in the figures may be exaggerated relative to other elements to help improve understanding of different illuminating assemblies. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the illuminating assemblies and methods and process of installing or arranging of the same described herein are, for example, capable of operation in sequences other than those illustrated or otherwise described herein.

Furthermore, the terms “include,” and “have,” and any variations thereof, are intended to cover a non-exclusive inclusion, such that a process, method, arrangement, article, or apparatus that comprises a list of elements is not necessarily limited to those elements, but may include other elements not expressly listed or inherent to such arrangement, process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the illuminating elements, illuminating arrangements and methods and processes for manufacturing the same described herein are, for example, capable of operation in other orientations than those illustrated or otherwise described herein. The term “coupled,” as used herein, is defined as directly or indirectly connected in an electrical, physical, mechanical, optical, or other manner. The term “on,” as used herein, is defined as on, at, or otherwise adjacent to or next to or over.

The terms “couple,” “coupled,” “couples,” “coupling,” and the like should be broadly understood and refer to connecting two or more elements, mechanically, electrically, optically, and/or otherwise, either directly or indirectly through intervening elements. Coupling may be for any length of time, e.g., permanent or semi-permanent or only for an instant. The absence of the word “removably,” “removable,” and the like near the word “coupled,” and the like does not mean that the coupling, etc. in question is or is not removable.

The term “translucent”, if used, describes a material that is translucent and/or partially transparent.

### DESCRIPTION OF THE DRAWING

FIG. 1 is a front elevation view of an LED, edge-lit illumination panel encased within a polymeric material (illumination element) constructed in accordance with the present invention.

FIG. 2 is a perspective exploded view of the illumination element of FIG. 1.

FIG. 2a is a top view of an illumination element constructed in accordance with the present invention.

FIG. 2b is a top view of an illumination element constructed in accordance with the present invention.

FIG. 2c is a top view of an illumination element constructed in accordance with the present invention.

FIG. 2d is a top view of an illumination element constructed in accordance with the present invention.

FIG. 2e is a top view of an illumination arrangement constructed of plurality of illumination elements to create a larger surface area in accordance with the present invention.

FIG. 2f is a top view of an illumination arrangement constructed of plurality of illumination elements to create a larger and asymmetric surface area in accordance with the present invention.

FIG. 3 is a side view of the LEDs coupled to a lightguide of the illumination element of FIG. 1.

FIG. 4 is a front elevation view of an LED, edge-lit illumination panel assembly of LED light source used as edge lighting and v-cut planar lightguide panel;

FIG. 5 is a front elevation view of an LED, edge-lit illumination panel assembly of LED light source used as edge lighting and dot-printed planar lightguide panel;

FIG. 6 is a front elevation view of an LED, edge-lit illumination panel assembly of LED light source used as edge lighting and dot-etched planar light guide panel;

FIG. 7 is a front elevation view of an LED, edge-lit illumination panel assembly of LED light source used as edge lighting and microlenses, microprisms or microstructure planar light guide panel;

FIG. 8 is a schematic drawing of electrical circuitry of LEDs according to the present invention.

FIG. 9 is exemplary schematic drawings of foam forms to form contours, shapes, figures, outlines, silhouette, profiles, indentations and structures for use in practicing the present invention.

FIG. 10a is a schematic, cross-sectional drawing of a foam form and the contour form developed as a result of pouring and curing a concrete or aggregate compound, and the resulting spaces or cavities to hold the illumination element and the power and controlling conductors.

FIG. 10b is the schematic drawing of poured and cured concrete or aggregate form of FIG. 10a, with the placed illumination assembly and a solid objects or an artifact according to the present invention.

FIG. 11a is a schematic drawing of a solid objects or an artifact and illumination assembly made part of the foam form according to the present invention.

FIG. 11b is the schematic drawing of poured and cured concrete or aggregate form of FIG. 11a, with the placed illumination assembly and an a solid objects or artifact according to the present invention.

### DESCRIPTION OF THE PREFERRED ARRANGEMENT

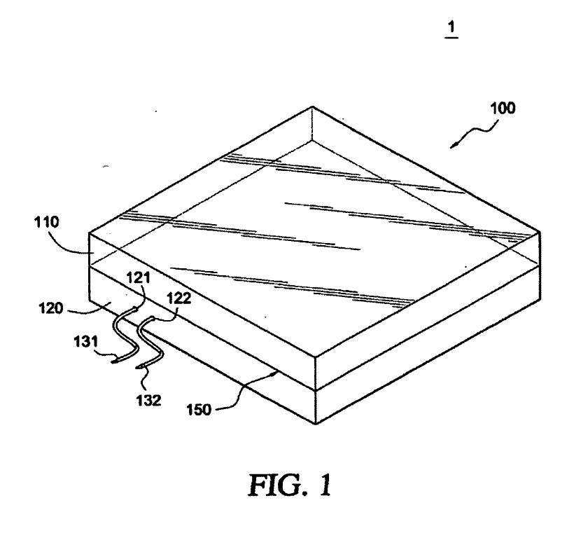

First, the LED/PS encased in a polymeric material that constitutes the illumination element of the present invention is described. FIG. 1 demonstrates an exemplary illumination element of the present invention. The illumination elements of the present invention illuminate more evenly, use less energy than other conventional lamp technologies, do not require high voltage ballasts, contain no mercury gas, are cool, have a substantially longer life span and offer other advantages such as having a smaller physical form and a lower profile (e.g., avoiding hot stops and the need for diffusers and such) among other advantageous attributes.

In general, an illumination element comprises of a series of light emitting diodes (LEDs) arranged linearly on a circuit board and coupled to electric power, the LEDs adapted to project light into a flat lightguide (panel) through at least one edge of the lightguide. This type of assembly is well-known in the art as edge-lighting. The lightguide may have a reflective surface on the back (i.e., white reflective paint), have light diverting members such as laser-etched grooves or printed dots formed on the upper surface of the lightguide to divert light, and an upper light diffusing member (i.e., diffusion film) to evenly distribute the light as is well known in the art. It is noted that although such an assembly can function according to the present invention; nonetheless, it is not the most preferred assembly, as this type of assembly is not protected from the environment and difficult to handle during manufacturing, installation and maintenance.

A more preferred illumination element encloses the above assembly within a polymeric enclosure. This enclosure completely encases the above assembly to protect the assembly against the environment and make handling easier during installation and maintenance. The enclosure of the arrangement has an upper surface, a lower surface located substantially opposite the upper surface, and sides forming the perimeter around the edges of the upper and lower surfaces to form an enclosure. Hereinafter, illumination element refers to an encased or enclosed LEP/PS according to the present invention.

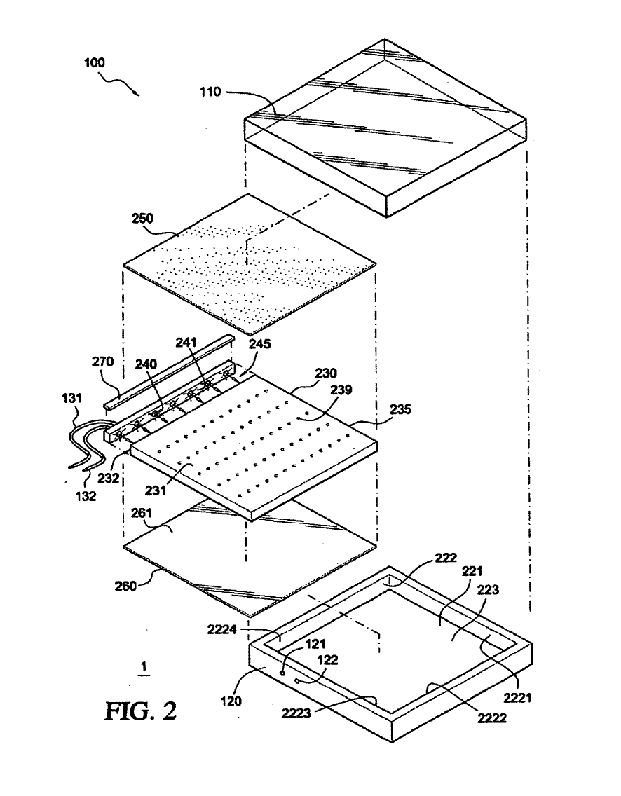

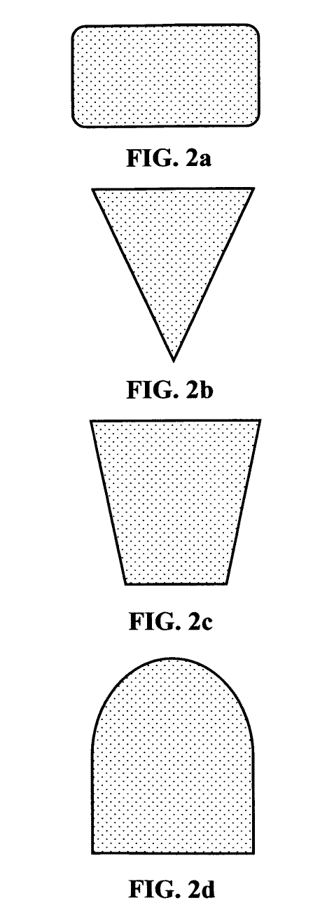

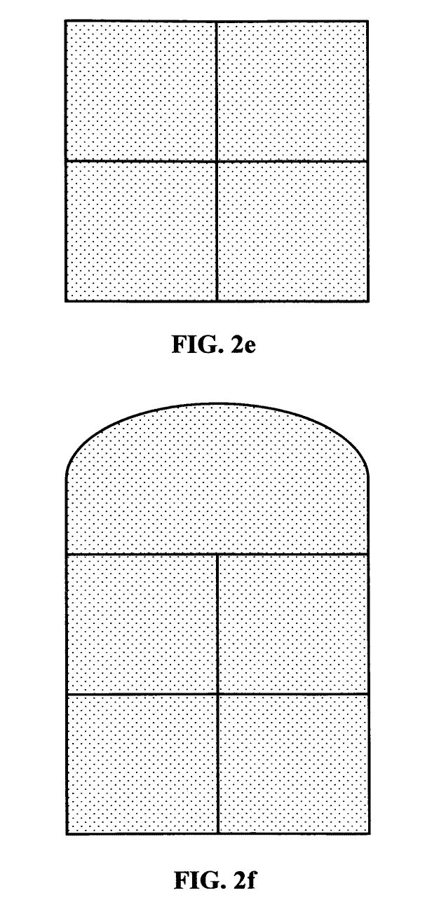

Referring back to the figures, FIG. 1 illustrates a perspective view of the preferred illumination element 1 comprising the LEDs 100. FIG. 2 illustrates a perspective exploded view of illumination element 1 with upper surface 110, lower surface 120 and coupled together at junction 150 (FIG. 1). As described in further detail below, illumination element 1 comprises internal lighting that emits light visible through upper surface 110, where upper surface 110 is at least partially translucent. As a result, light emitting from the upper surface 110 of illumination element 1 backlights an artifact, a transparent or translucent object or article (as will be shown later) when turned on or otherwise energized. In the present example, upper surface 110 comprises a polymethyl methacrylate (PMMA) material such as HFI10100 from Atofina Chemicals, Inc. of Philadelphia, Pa., USA. Another example of upper surface 110 could use a PMMA material such as DF100, also from Atofina Chemicals, Inc. Although normally transparent, the PMMA material could also be pigmented if desired. In other examples, upper surface 110 can comprise a different plastic material, such as a polyester, polyamide, polycarbonate, high impact polystyrene, polyvinyl chloride (PVC), and/or acrylonitrile butadiene styrene (ABS), among others. Still other illumination element can comprise a glass material for upper surface 110.

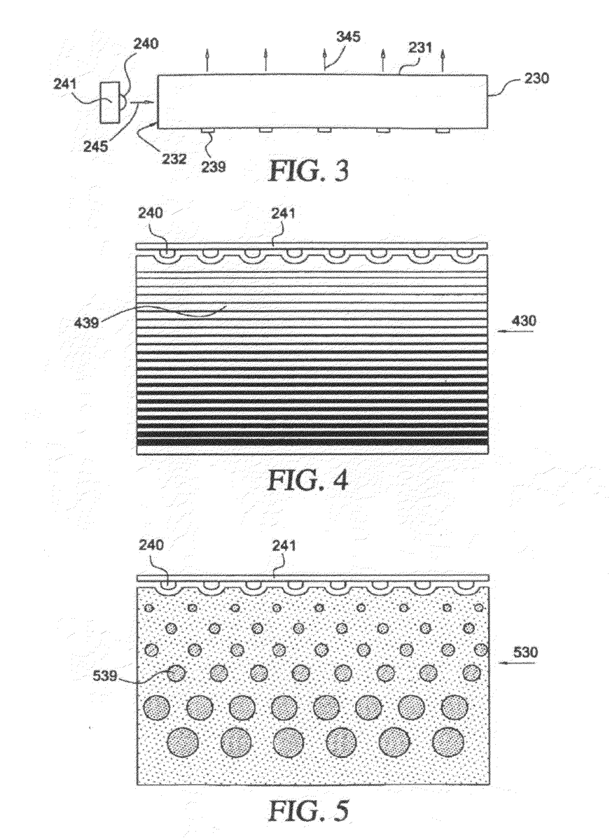

FIG. 2 illustrates a perspective exploded view of illumination element 1 further comprising diffusive layer 250 located between sides 231 of lightguide 230 and upper surface 110. In the present example, diffusive layer 250 is configured to diffuse light directed towards upper surface 110. For example, diffusive layer 250 can be translucent, partially transparent, and/or frosted to diffuse portion 345 (FIG. 3) of light 245 evenly across upper surface 110. Other assemblies may eliminate the use of diffusive layer 250, particularly when lightguide 230 serves the same or similar function as diffusive layer 250.

illumination element 1 also comprises reflective layer 260 in the present assembly, where reflective layer 260 may comprise reflective sheet 261 located between lightguide 230 and inside surface 221 of lower surface 120. Reflective layer 260 can be configured to reflect at least a portion of light 245 that shines through side 232 of lightguide 230 back towards upper surface 110. In a different assembly, reflective layer 260 can be eliminated, particularly where inside surface 221 serves the same function of reflective layer 260. Other examples may also forego the use of reflective layer 260. In yet another assembly, reflective layer 260 can be eliminated, particularly where the back of lightguide 230 is, for instance, reflective paint on the back of lightguide 230.

Continuing with the assembly of FIG. 2, assembly 1 also comprises hot spot blocking mechanism 270 positioned between upper surface 100 and at least a portion of light sources or LEDs 240. Hot spot blocking mechanism 270 also can be located between diffusive layer 250 (when used) and carrier or circuit board 241. Hot spot blocking mechanism 270 is opaque, and can thus be used to block or diminish the appearance of “hot spots” or concentrations of light around the one or more light sources 240 in order to aid in the uniform distribution of light 245 towards upper surface 110. In the present example, hot spot blocking mechanism comprises a strip of metallic foil, although other materials such as an opaque plastic are also within the scope of the present invention. Other examples may forego the use of hot spot blocking mechanism 270.

It is understood that the upper and lower surfaces and the perimeter sides 222, 2221, 2222 and 2223 that in conjunction with the upper surface 110 and the surface 221 form an enclosure as shown. The perimeter sides 222, 2221, 2222 and 2223 are schematically shown in FIG. 2 to be an integral part of the lower surface 120, but these sides can be fabricated separately and attached later. However, in practice, it is preferred to form the upper or lower surface with perimeter sides integrated therein to minimize the number of parts and facilitate ease of manufacturing and handling. For instance, the perimeter sides can be integrated during molding process as is well known in the art. Further, it is understood that the illumination elements are shown in essentially square form; but in practice, there are no limitations on the form (i.e., triangular, rectangular, elliptical or hexagonal. etc.) and asymmetrical forms can also be made according to the present invention. FIGS. 2a through 2d show the top view of some of the possible forms.

It is understood that the lower surface 120 and perimeter surfaces 222, 2221, 2222 and 2223 can also be made from the same materials as disclosed for upper surface 110 above, or of other materials as desired.

In addition to the different shapes shown in FIGS. 2a to 2d, it is noted that illumination element sections can be positioned adjacent (e.g., contiguous arrangement) to each other to form any shape to adequately backlit objects or artifacts according to the present invention. For instance, four illumination element s with substantially square shapes can be placed next to each other to form a larger square surface (FIG. 2e). Conversely, a half-circle or half-moon can be added to the four square section of FIG. 2e to form a surface shape as shown in FIG. 2f. It is also noted that by being able to position illumination element sections in the manner described herein (e.g., in a modular and in a contiguous arrangement), the need to fabricate custom shapes for every solid objects or artifact is eliminated, resulting in substantial cost savings.

Light sources or LEDs 240 of the lighting assembly 1 may be manufactured on a rigid or flexible circuit board 241 and designed in different formats as desired. FIG. 8 illustrates an electrical schematic of circuitry 800 for one or more LEDs 240 of LEP 1 (FIGS. 1-2). Circuitry 800 can comprise power supply circuit 810 to power at least a portion of one or more LEDs 240. In the present example, power supply circuit 810 couples to light sources 240 through leads 131-132 to supply rated power magnitude 820 of approximately 12 Volts DC (direct current). Although light sources 240 are rated to handle at least approximately 12 Volts DC in the present assembly, other assemblies may comprise light sources (LEDs) configured to handle a different rated power magnitude, such as approximately 3 Volts DC or 24 Volts DC.

It is understood that, although series of LEDs in FIG. 2 are shown to project light into lightguide 230 only on one edge 232, if necessary to increase the intensity or for other illumination effects, to project light from more than one side as is well known in the art.

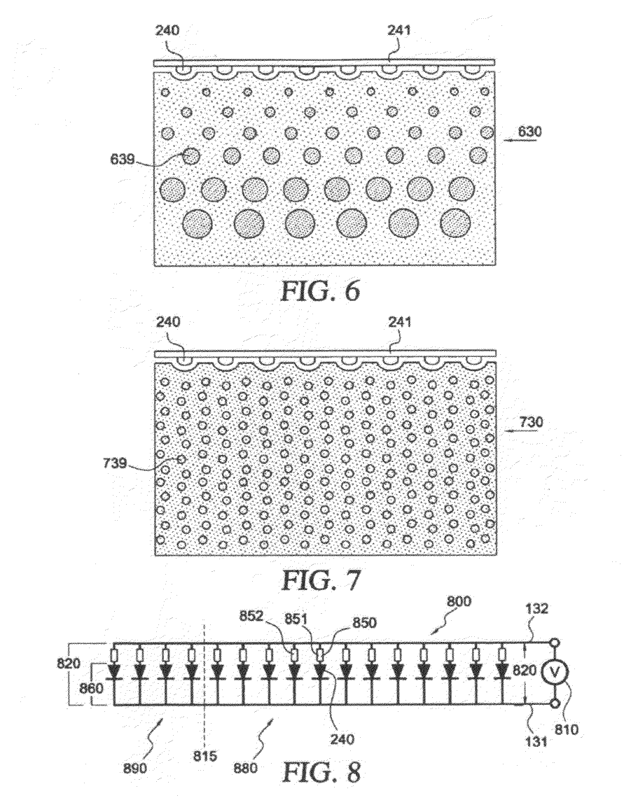

FIG. 3 illustrates a side view of lightguide 230 coupled to one or more LEDs 240 of assembly 1. Lightguide 230 comprises features 239 configured to direct at least portion 345 of light 245 towards upper surface 110. In the present example, features 239 are substantially evenly distributed across lightguide 230 and can also shine portion 345 of light 245 in a substantially uniform pattern towards upper surface 110. In other assemblies, lightguide 230 can comprise features different from features 239 to direct light towards upper surface 110 (FIGS. 1 and 2) in a substantially uniform pattern. As an example, FIG. 4 illustrates a top view of lightguide 430 comprising v-cut lightguide features 439, and FIG. 5 illustrates a top view of substrate 530 comprising dot-printed lightguide features 539. As further examples, FIG. 6 illustrates a top view of lightguide 630 comprising dot-etched light guide features 639, and FIG. 7 illustrates a top view of lightguide 730 comprising microlens, microprism, and/or microstructure light guide features 739.

In some examples, the features of lightguide 230 of assembly 1, such as features 239 (FIGS. 2 and 3), 439 (FIG. 4), 539 (FIG. 5), 639 (FIG. 6), and/or 739 (FIG. 7), can be capable of shining a portion of light 245 in a substantially uniform pattern towards upper surface 110 (FIGS. 1 and 2) even if the features themselves are not substantially evenly distributed across their respective lightguide or differ in size and/or concentration. In any event, because upper surface 110 is partially translucent, it can permit at least portion 345 of light 245 to shine through upper surface 110 (FIGS. 1 and 2) and to be visible from an exterior of arrangement 1.

As mentioned before, organic light emitting diodes (OLEDs) can be used as a light source in the present invention. In such instances, where OLEDs are used, the OLED can be placed within the upper surface 110 and lower surface 120, and accordingly there is no need to mount LEDs onto a circuit board like circuit board 241 (FIG. 2), or to align light sources with respect to an edge like edge 232 of lightguide 230 (FIGS. 2-3). The use of OLEDs in this manner also eliminates the need for hot spot blocking mechanism 270 (FIG. 2).

The present illumination elements may comprise derating circuit 850 configured to deliver a derated power magnitude 860 to one or more LEDs 240, where derated power magnitude 860 is less than rated power magnitude 820. In the present example, derating circuit 850 comprises resistance elements coupled between a node of lead 132 and each of LEDs 240 to generate derated power magnitude 860. Each one or more LEDs 240 is thus coupled to a different one of the one or more resistance elements of derating circuit 850 in the present example. As an example, the one or more resistance elements can comprise resistors 851-852, but other resistance elements can be used. Resistance values for the resistance elements may be tailored depending on, for example, a target lifetime for LEDs 240, the output of power supply circuit 810, and/or on the type or brand of light sources 240. By providing light sources 240 with derated power magnitude 860, instead of rated power magnitude 820, the longevity of light sources 240 can be increased accordingly.

In some instances, it may be desirable to project a certain illumination (i.e., different color temperature, relatively higher color rendering index or infrared for night vision and such) to accentuate a graph or color of an object or an artifact being illuminated by the illumination element. In such instances a mixture of white LEDs and other color LEDs such as red, orange or yellow among other colors may be used. In another variation, a colored film may be placed between the upper surface of surface 250 and the upper surface 110 of the enclosure to vary the color of light emanating from the LEP. In one instance, for example, a Lee Gel Roll HI Sodium R651 manufactured by Lee Filters of Burbank, Calif., USA was used to create a “high-pressure-sodium-illumination” look using LED/PS s with very high temperature light color (e.g., over 7,000 degree Kelvin) that otherwise looked very white and very pale. In some instances, red-green-blue (RGB) LEDs may be used to achieve the desired color as is well known in the art.

Referring now back to the use of illumination elements and illumination arrangements made thereof using plurality of illumination elements, along with foam forms according to the present invention.

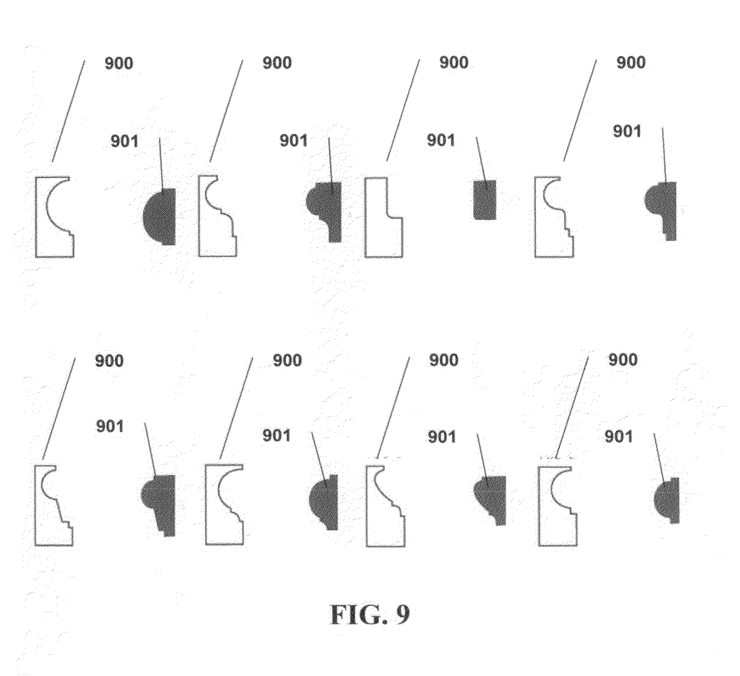

It is noted that use of foam forms to pour concrete or other aggregate materials such as polyurethanes and the like to form contours, shapes, figures, outlines, silhouette, profiles, indentations, structures and the like in the architectural industry is well known and practiced in the art. For example, Foam Architectural Products, Inc. of Santa Rosa, Calif., USA offers a line of such foam forms or molds for forming coping around pools. FIG. 9 demonstrates exemplary schematic drawings of such molds. Outlines 900 are the outlines of the foam forms and outlines 901 are the contours that will result after the poured aggregate or concrete is cured. The forms above create cantilevered pool copings approximately 90 to 150 mm high and 30 to 80 mm wide. There are no limitations as to the overall size of the formed contours, shapes, figures, outlines, silhouette, profiles, indentations and structures. In some instances, contours, shapes, figures, outlines, silhouette, profiles, indentations and structures as large as several meters are possible.

Like the foam forms offered by Foam Architectural Products, SureCrete Design Products of Dade City, Fla., USA offers a line of products for countertops, and similarly Coral Stone of Myrtle Beach, S.C., USA offers a line of molds for creating aesthetically pleasing fireplace surrounds. A video available at http://www.youtube.com/watch?v=6eQajbGDbo4&feature=related demonstrates “how to form and pour cantilevered concrete” using the above foam forms and molds, for example.

It is also noted that there are many variations of how the foam forms may be used in practicing the present invention.

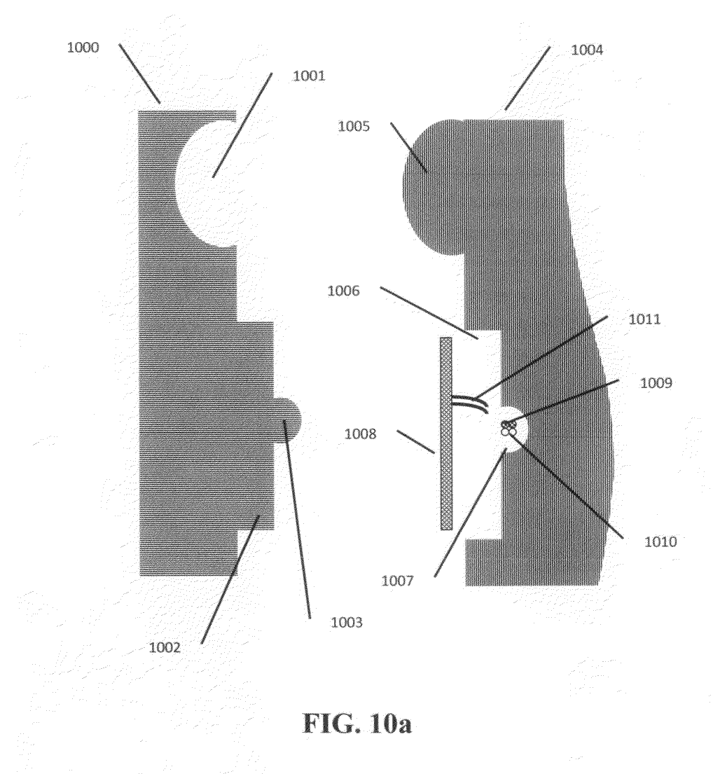

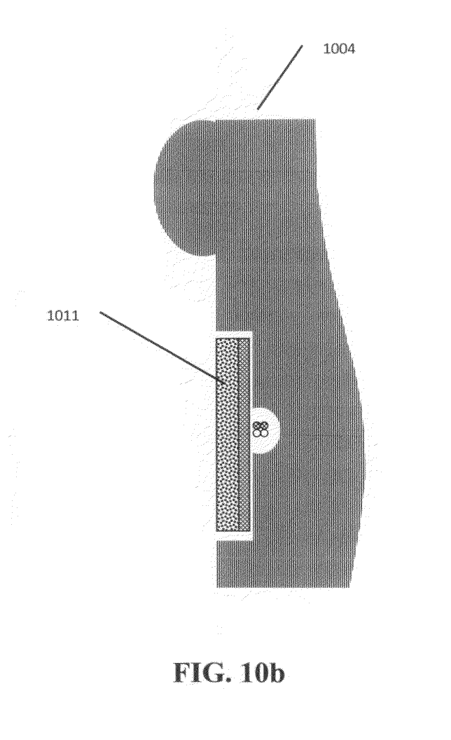

In the exemplary variation as schematically illustrated in FIG. 10a, an exemplary foam form 1000, with a substantially large round indentation 1001, a substantially rectangular cross-sectional protrusion 1002 and a substantially half-round cross-sectional protrusion 1003 and the resulting form 1004 is demonstrated. The form 1004 depicted here as a result of curing a concrete or aggregate form using the form 1000 has cantilever contour 1005 as a result of the large round indentation 1001, the cavity 1006 as a result of rectangular cross-sectional protrusion 1002 and the cavity 1007 as a result of half-round cross-sectional protrusion 1003. The space or cavity 1006 has intentionally been created for subsequent placement of an illumination element 1008 and the cavity 1007 has intentionally been created for the placement of the power conductors 1009 and control conductors 1010 according to the present invention. It is noted that although the large indentation 1001 may be a normal part of foam forms or molds as demonstrated in FIG. 9; nonetheless, the rectangular cross-sectional protrusion 1002 and the half-round cross-sectional protrusion 1003 are peculiar to the present invention. It is noted that once more than one illumination element 1008 is used, an illumination arrangement is made. This may be accomplished by arranging the illumination elements contiguously next to each other, or non-contiguously if so desired, but in close proximity (not more than 500 mm apart, preferably not more than 250 mm apart and more preferably not more than 100 mm apart and most preferably not more than 50 mm apart). In practice, first wires 1011 extending from the illumination element 1008 are connected to the wire conductors 1009 and 1010 running along and within the space or cavity 1007 (a conduit may be placed in cavity 1007 to contain the conductors 1009 and 1010), using appropriate connectors and/or junctions (not shown). Next, the illumination element 1008 is secured to the poured concrete or aggregate 1004 by various methods customary in the building industry such as by adhesive, grout or anchors and the like. Lastly, an artifact 1011 may be added, if desired. An exemplary completed assembly as described above is demonstrated in FIG. 10b for clarification. Artifact(s) 1011 as the last component may substantially cover the top of illumination element 1008 or a portion of thereof or an illumination arrangement (a plurality of illumination elements) may backlight one artifact. The artifact can be like a glass block or tile, or a thin plate of plastic or glass with special effects on the surface, etc. In this manner, the illumination element or arrangement backlights the artifact when energized creating a dazzling effect not possible before.

The assembly may be flush within the cavity 1006 or be set within the interior of the cavity 1006 or extend out of the cavity 1006.

It is noted that there is no limit as to the dimensions of illumination elements, illumination arrangements and/or solid objects in practicing the process or method of the present invention.

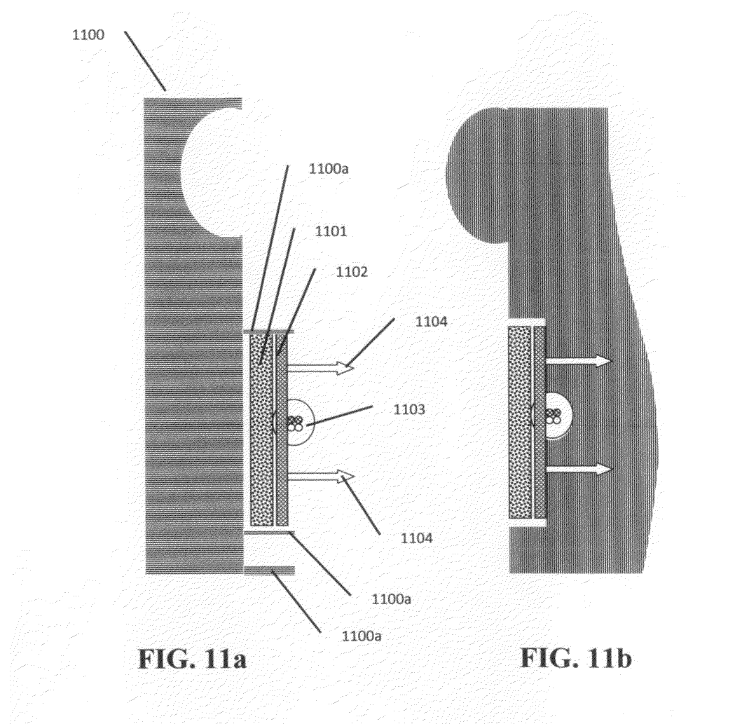

In another exemplary variation of the present invention, in very simple terms, the illumination element, arrangement, possibly the solid object, the conduit containing and enclosing the power and control conductors and suitable anchors are manufactured as part of the foam form or mold. In this variation, referring to FIG. 11a, there is illustrated foam form 1100, exemplary rectangular object 1101 in accordance to the present invention (e.g., shown in this cross-sectional configuration as an example only, noting that other cross-sectional configurations such as triangular, circular, elliptical, etc. are possible), an exemplary rectangular illumination element 1102 as a cross-sectional configuration (e.g., shown in this cross-sectional configuration as an example only, noting that other cross-sectional configurations such as triangular, circular, elliptical, etc. are possible), a half-circular conduit 1103 containing and enclosing the power and control conductors (e.g., shown in this cross-sectional configuration as an example only, noting that other cross-sectional configurations such as triangular, circular, elliptical, etc. are possible), and anchors 1104, if desired, are attached to the back of the illumination element 1102 prior to and during pouring the aggregate or concrete. It is noted that foam form 1100 includes extensions 1100a to hold object, illumination element and the conduit and anchors attached to the form prior to and during pouring and curing of the aggregate or concrete. It is also noted that a protective film or a thin sheet of a material such as a polyester may be placed between the surface of the solid object 1101 and foam form 1100 to protect the surface of the solid object during the removal of the foam and finalizing the installation.

Referring back to FIG. 11, the poured and cured structure 1110b after removal of the foam form 1100 is demonstrated. It is noted that anchors 1104 are now imbedded in the cured aggregate or concrete securing the placement of the illumination element 1102. The area around the illumination element 1102 and solid object 1101 can be finished with grout or a structural material such as silicone.

In accordance with the invention; the method or process and assemblies of two exemplary variations are provided in association with perimeter of a pool. It is noted that the same variations can be provided in other architectural structures such as the upper caps of cinder block walls, fireplace surrounds and other pre cast concrete and stonework decorations, aggregate compounds such as window frames and polyurethane props such as columns and the like.

Herein are disclosed two exemplary and novel processes or methods of forming and installation of lighting assemblies, which in the first method, include the following steps:
pre-fabricating foam forms including indentions and protrusions for architectural and/or aesthetic effects such as cantilever coping around pools, and also including protrusions to form appropriate cavities or spaces facing the illumination direction,
pouring and curing aggregate compound or concrete to form the architectural and/or aesthetic effects and appropriate cavities or spaces,
removing the foam forms to expose the architectural and/or aesthetic effects and appropriate cavities or spaces,
the cavities and spaces formed suitable for placement of at least power conductors to energize illumination elements (arrangement), and placement of control conductors, if desired, to create illumination effects such as color changing, dimming and such,
the cavities and spaces formed suitable for placement of illumination elements in accordance with the present invention projecting light in the illumination direction,
securing the illumination elements to the cavity by use of adhesive, grout or other suitable materials within the cavity (e.g., in the back and/or around the illumination elements),
providing means on the surface of the illumination elements or around the edges of the illumination elements according the present invention to accept solid objects or artifacts such as glass tiles, glass blocks and such,
where the objects and artifacts when back-lit by the illumination elements in accordance with the present invention provide dazzling light effects.

And, which in the second exemplary method, include the following steps:
pre-fabricating foam forms including indentions and protrusions for architectural effects such as cantilever coping around pools,
further including artifact to be exposed later in the direction of illumination by illumination element behind the artifact,
the foam form including conduit behind the illumination elements suitable for placement of at least power conductors to energize illumination elements (arrangement), and placement of control conductors, if desired, to create illumination effects such as color changing, dimming and such,
the foam forms including attachment members such as anchors attached behind the illumination elements,
pouring and curing aggregate compound or concrete using the above foam form to form the architectural effects, imbedding the anchor in the aggregate or concrete,
removing the foam form to expose the architectural effects and the artifact,
finishing around the artifact using adhesive, grout or other suitable materials,
illumination elements in accordance with the present invention projecting light in the illumination direction,
the artifacts when back-lit by the illumination elements in accordance with the present invention provide light dazzling effects.

Since many changes could be made in the above exemplary methods and processes in the constructions and installations. It is obvious that widely different, arrangements, assemblies, methods and processes of this invention could be made without departing from the scope thereof, it is intended that all matter contained in the drawings and specification shall be interpreted as illustrative and not in a limiting sense.

Although the illuminating elements, arrangements, assemblies, methods and processes for creating the same have been described with reference to specific arrangements, various changes may be made without departing from the spirit or scope of the disclosure herein. Various examples of such changes have been given in the foregoing description. These and other modifications would not interfere with or depart from the concepts described herein.

Accordingly, the disclosure of illuminating elements, arrangements, assemblies, methods and processes for creating the same is intended to be illustrative of the scope of the application and is not intended to be limiting. It is intended that the scope of this application shall be limited only to the extent required by the appended claims. For example, it will be readily apparent that the artifacts discussed herein may be implemented in a variety of forms and shapes, and that the foregoing discussion of certain of these artifacts does not necessarily represent a complete description of all possible artifacts. As a specific example, although artifacts have been described devoid of any graphics, there may be examples where the surface of the artifact comprise graphics and patterns that block and/or accentuate the light.

All elements claimed in any particular claim are essential to the illuminating assembly claimed in that particular claim. Consequently, replacement of one or more claimed elements constitutes reconstruction and not repair. Additionally, benefits, other advantages, and solutions to problems have been described with regard to specific arrangements. The benefits, advantages, solutions to problems, and any element or elements that may cause any benefit, advantage, or solution to occur or become more pronounced, however, are not to be construed as critical, required, or essential features or elements of any or all of the claims.

Moreover, arrangements and limitations disclosed herein are not dedicated to the public under the doctrine of dedication if the arrangements and/or limitations: (1) are not expressly claimed in the claims; and (2) are or are potentially equivalents of express elements and/or limitations in the claims under the doctrine of equivalents.

1. A process, comprising of:
selecting a foam form for creating a structure;
the foam form having at least one protrusion;
the at least one protrusion capable of creating at least one cavity;
the at least one cavity adapted to receive an illumination element thereof.

2. The process of claim 1 where the illumination element is an encased, LED edge-lit panel system.

3. The process of claim 1 where the illumination element is adapted to backlit an artifact or a solid object.

4. A process, comprising of:
selecting a foam form for creating a structure;
the foam form having at least one protrusion;
the at least one protrusion capable of creating at least one cavity;
the at least one cavity adapted to receive an illumination element;
the foam form further having at least one indentation;
the at least one indentation capable of forming an aesthetic or an architectural effect.

5. The process of claim 4 where the illumination element is an encased, LED edge-lit panel system.

6. The process of claim 4 where the illumination element is adapted to backlit an artifact or a solid object.

7. The process of claim 4 where the aesthetic or an architectural effect is a coping for a swimming pool.
